(19) United States
(12) Patent Application Publication
(10) Pub. No.: US 2010/0205482 A1
(43) Pub. Date: Aug. 12, 2010

(54) MIRRORING CONTROLLER, STORAGE DEVICE, AND MIRRORING CONTROL METHOD

(75) Inventor: Himiko Kaneko, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/703,941

(22) Filed: Feb. 11, 2010

(30) Foreign Application Priority Data
Feb. 12, 2009 (JP) 2009-29309

(51) Int. Cl. G06F 12/16; G06F 11/20

(52) U.S. Cl. 714/6; 711/117; 711/162; 711/E12.103; 714/E11.104

(57) ABSTRACT

A mirroring controller includes a copy controller that selects one memory from among the plurality of memories as a copy source memory and copies data from the copy source memory to at least one copy target memory; and an I/O mirroring controller that copies, when a read request to the copy source memory is issued from an upper layer during copying by the copy controller, data from an area corresponding to the read request to the copy target memory, wherein, when processing corresponding to the read request to the copy source memory from the upper layer results in an error at the copy source memory during the copying by the copy controller, the copy controller controls the copy source memory so as to become unusable, and controls at least one copy target memory so as to act as a memory.

### CROSS-REFERENCE TO RELATED APPLICATIONS

This application is based upon and claims the benefit of priority of the prior Japanese Patent Application No. 2009-29309, filed on Feb. 12, 2009, the entire contents of which are incorporated herein by reference.

### FIELD

The present invention relates to a mirroring controller, a storage device, and a mirroring control method that enable data integrity by disk redundancy using a mirroring (software RAID) function of a magnetic disk device.

### BACKGROUND

There is a mirroring controller for achieving data integrity by disk redundancy and improvements in the reliability and availability of computer systems by using a mirroring (software RAID) technology that makes a plurality of magnetic disk devices redundant.

FIGS. 13A to 13D depict an example of the operation of a conventional mirroring controller when a system goes down and the mirroring state is restored after a restart of the system.

First, in the normal operation state, since the disks (21) of both systems are active, reading and writing by the application software of the upper layer are performed on both disks (see FIG. 13A). For example, in a case where a system goes down due to a factor other than the disk and is restarted when the disks of both systems are both normal, data copying from the disk of one system (hereinafter, referred to as “copy source disk”) to the disk of the other system (hereinafter, referred to as “copy target disk”) is performed in order to restore the mirroring state (see FIG. 13B). During this data copying, reading by the application software of the upper layer is performed from the copy source disk and writing by the application software of the upper layer is performed to both of the disks.

When an error occurs at the copy source disk during the data copying, copying is aborted (see FIG. 13C). Moreover, at this time, since the copying to the copy target disk has not been completed yet and the contents cannot be guaranteed, the conventional mirroring controller controls the copy target disk so as to be isolated from mirroring. Consequently, only the copy source disk acts as the operating disk, and reading and writing by the host server are performed only on the copy source disk (see FIG. 13D).

As technologies associated with the present invention, Japanese Unexamined Patent Application Publications Nos. H11-259519 and H07-134635 are disclosed.

In the operation of the conventional mirroring controller, when an error occurs at the copy source disk during the data copying for restoring the disk mirroring state, the copy source disk is in a state where the error occurs, and the copy target disk is in a state where data cannot be guaranteed. As described above, in the conventional mirroring controller, even though the copy target disk is accessible and in a state where data is guaranteed before the start of copying, if an error occurs at the copy source disk during the copying, the copy target disk also becomes unusable, and neither data guarantee nor operation continuation is possible.

For recovery from such a condition, it is necessary to replace the disk where the error occurs and restore the backup data previously stored on a tape or the like. Therefore, it is necessary to halt the operation until the restoration is completed, and the differential data between the data state backed up on the tape and the data state when the error occurs at the copy source disk is lost.

### SUMMARY

According to an aspect of the invention, a mirroring controller that maintains data redundancy by a plurality of memories includes:

a copy controller that selects one memory from among the plurality of memories as a copy source memory and, to obtain data equivalence between the plurality of memories, copies data from the copy source memory to at least one copy target memory that is different from the copy source memory among the plurality of memories; and

an I/O mirroring controller that copies, when a read request to the copy source memory is issued from an upper layer during copying by the copy controller, data from an area corresponding to the read request to the copy target memory,

wherein when processing corresponding to the read request to the copy source memory from the upper layer results in an error at the copy source memory during the copying by the copy controller, the copy controller controls the copy source memory so as to become unusable, and controls at least one copy target memory so as to act as a memory that performs the processing corresponding to the read request from the upper layer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts an example of functional blocks of a storage device according to the present embodiment;

FIGS. 2A to 2D depict an example of the operation of a disk mirroring controller according to the present embodiment;

FIGS. 3A and 3B depict an example of the data structure of a mirror disk structure management table according to the present embodiment;

FIGS. 4A to 4C depict an example of the data structures of a copy management table and an update area management table according to the present embodiment and the association between the bits in each of the copy management table and the update area management table and the areas of a mirror disk;

FIG. 5 is a flowchart of reading during the execution of restoration copying according to the present embodiment;

FIG. 6 is a flowchart of writing during the execution of the restoration copying according to the present embodiment;

FIG. 7 is a flowchart (part 1) of the restoration copying according to the present embodiment;

FIG. 8 is a flowchart (part 2) of the restoration copying according to the present embodiment;

FIG. 9 is a flowchart of an operating disk change processing according to the present embodiment;

FIG. 10 is a flowchart of copying to the copy target disk according to the present embodiment;

FIG. 11 depicts an example of the hardware structure of the disk mirroring controller according to the present embodiment;

FIG. 12 is a modification of the structure depicted in FIG. 1, according to the present embodiment; and

FIGS. 13A to 13D depict of the operation of the conventional mirroring controller when the system goes down and the mirroring state is restored after a restart.

### DESCRIPTION OF EMBODIMENTS

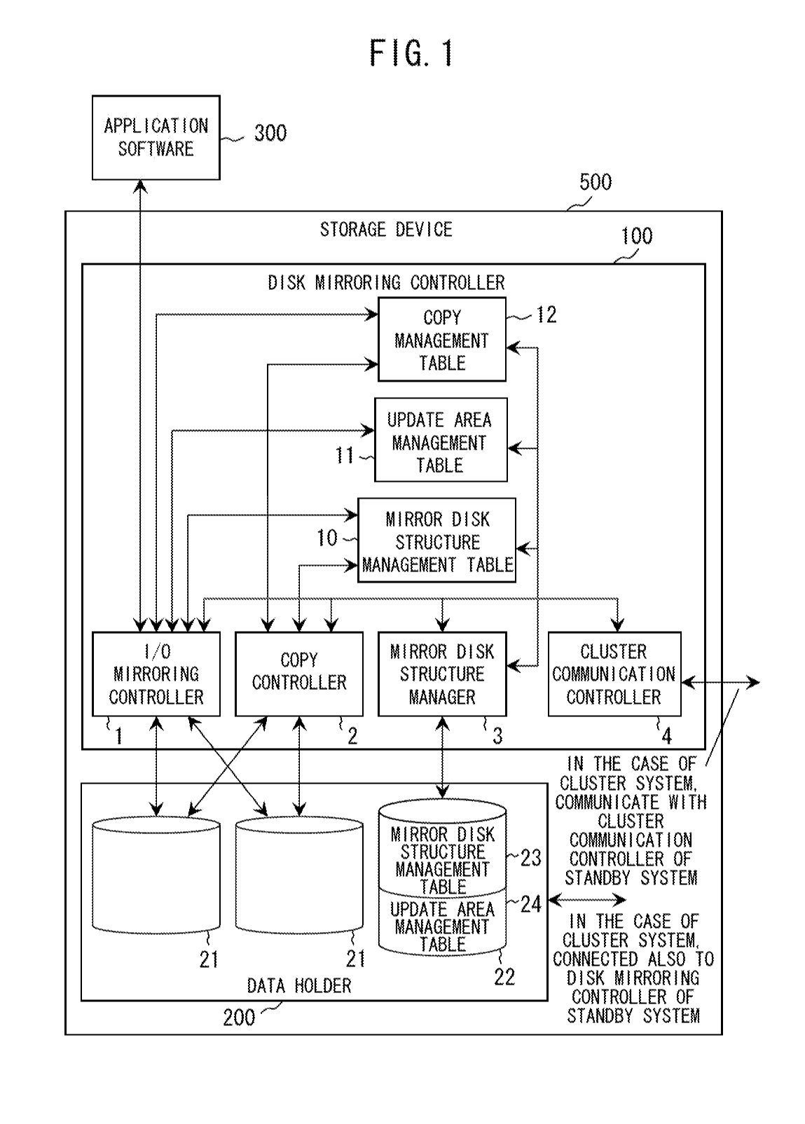

FIG. 1 depicts the structure of a storage device according to the present embodiment. The storage device 500 is provided with a disk mirroring controller 100 and a data holder 200.

The disk mirroring controller 100 is provided with an I/O mirroring controller 1, a copy controller 2, a mirror disk structure manager 3, and a cluster communication controller 4. As units for storing management data, the disk mirroring controller 100 is provided with a mirror disk structure management table 10, an update area management table 11, and a copy management table 12.

The data holder 200 is a set of magnetic disk devices to be controlled. The data holder 200 is provided with mirror disks 21 which are at least two magnetic disk devices that are in a mirroring state, and a management information disk 22 which is a magnetic disk device that holds the data of the management information. The management information disk 22 is provided with a mirror disk structure management table 23 and an update area management table 24 which are units that hold management information.

In the case of a cluster system, the data holder 200 is accessed from disk mirroring controllers of a plurality of systems making up the cluster system.

Now, functional blocks in the disk mirroring controller 100 will be described.

The I/O mirroring controller 1 implements disk mirroring by duplicating an I/O request to a disk issued by application software 300 that operates on a host computer and by issuing the duplicate I/O request to a plurality of mirror disks 21.

While the copy controller 2 is executing the copying for restoring the disk mirroring state after a system down, when the request from the application software 300 is a read request, the I/O mirroring controller 1 copies the data held in the area corresponding to the read request in the copy source disk to the copy target disk.

Further, when an error occurs during reading in an area while copying data of that area to the copy target disk according to a read request by the AP 300, the I/O mirroring controller 1 controls the copy source disk so as to be isolated (e.g., made unusable), and controls the copy target disk so as to act as the operating disk that performs the processing corresponding to the read request and the write request from the application software 300.

After the system goes down due to some unexpected trouble, the copy controller 2 performs data copying between the mirror disks 21, and restores the mirroring state of the mirror disks 21. That is, in order to obtain data equivalence between the mirror disks 21, the copy controller 2 selects one of the plurality of mirror disks 21 as the copy source disk and copies the data in the copy source disk to another copy target disk.

Further, when the processing corresponding to the read request or the write request accepted by the I/O mirroring controller 1 results in an error at the copy source disk during the copying by the copy controller 2, the copy controller 2 controls the copy source disk so as to be isolated, and controls the copy target disk so as to act as the operating disk.

The mirror disk structure manager 3 creates the mirror disk structure management table 10 by reading the mirror disk structure management table 23 from the management information disk 22 at system startup and loading it onto a RAM in the disk mirroring controller 100 (the hardware structure of the disk mirroring controller 100 will be described later), and creates the update area management table 11 by reading the update area management table 24 and loading the update area management table 24 onto the RAM in the disk mirroring controller 100. The mirror disk structure manager 3 updates the mirror disk structure management table 10 on the RAM and the mirror disk structure management table 23 on the management information disk 22 when the structure or the state of the mirror disks 21 is changed.

In the case of a cluster system, the cluster communication controller 4 performs communication for operation in concert with the other systems making up the cluster system. Specifically, the cluster communication controller 4 of a standby system detects that the operating system is down, and requests the own copy controller 2 to execute the copying for restoring the disk mirroring state. When the structure or the state of the mirror disks 21 is changed, notification is provided to the cluster communication controllers 4 of the other systems.

The mirror disk structure management table 10 holds the structure and state of the mirror disks 21 and the information on the position of the update area management table 24 on the management information disk 22, and the data is held on the RAM of the disk mirroring controller 100.

The update area management table 11 holds the information on the position of the area of the mirror disks 21 being updated, and the data is held on the RAM of the disk mirroring controller 100.

The copy management table 12 holds the information on the positions of the area to be copied and the area having been copied, during the execution of the copying for restoring the disk mirroring state after a system down, and is managed on the RAM of the disk mirroring controller 100.

Next, the inside of the data holder 200 will be described. The mirror disks 21 hold the duplicate of the write data of the I/O request issued by the application software 300.

The management information disk 22 holds the mirror disk structure management table 23 and the update area management table 24. The mirror disk structure management table 23 and the update area management table 24 are duplicates for holding in a non-volatile manner the mirror disk structure management table 10 and the update area management table 11 managed on the RAM of the disk mirroring controller 100.

Next, the operation contents of the disk mirroring controller 100 will be described.

When trouble occurs at the copy source disk, the disk mirroring controller 100 makes the copy target disk usable instead. As a precondition, although the data on the copy source disk and the data on the copy target disk before the start of the copying do not coincide with each other in some areas, the data on both the copy source disk and the copy target disk is made valid and useable.

When a read request is made to the copy source disk during the execution of the copying for restoring the disk mirroring state after a system down, the disk mirroring controller 100 copies the area to the copy target disk, and then, returns the read result to the application software 300. Both a method in which the area is copied irrespective of whether the area has already been copied or not been copied yet, and a method in which the area is copied only when the area has not been copied yet, are applicable to the disk mirroring controller 100.

When an error occurs at the copy source disk during the data copying for restoring the disk mirroring state after a system down, the disk mirroring controller 100 isolates the copy source disk from mirroring, and sets the copy target disk as the operating disk. When three or more disks are mirrored, the disk mirroring controller 100 sets one of the plurality of copy target disks as the operating disk, and performs copying to the other copy target disks with the operating disk as the new copy source disk.

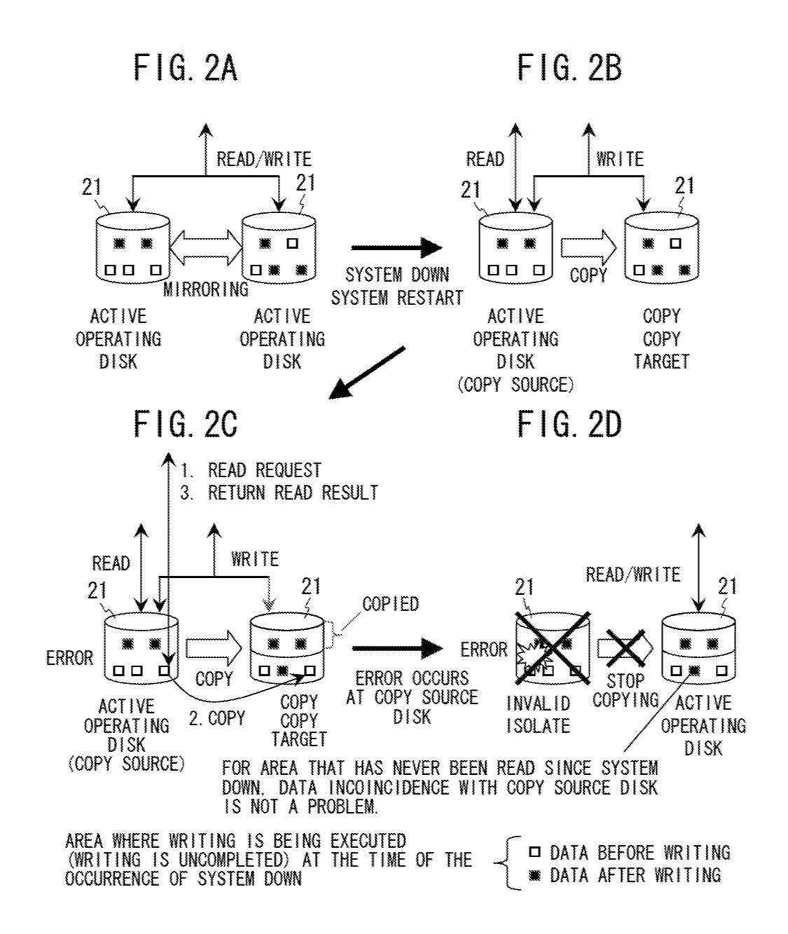

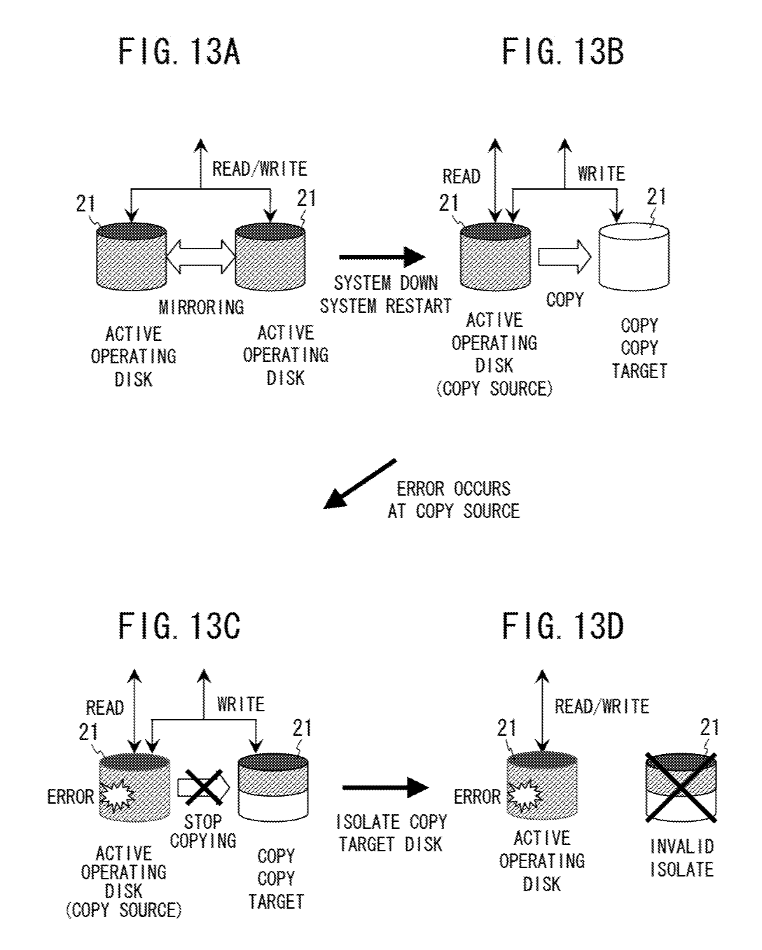

The above-described operation contents of the disk mirroring controller 100 are depicted in FIGS. 2A to 2D. According to the conventional technology, since there is a possibility that the data in an uncopied area of the copy target disk does not coincide with the copy source disk, the operating disk may not be changed. This problem is addressed by the following method: FIGS. 2A and 2B are not explained since they are similar to FIGS. 13A and 13B.

When a read request is made by the application software 300 to an area to be copied and reading of the copy source disk is successful during the data copying for restoring the disk mirroring state, the area is copied to the copy target disk, and then, the read result is returned to the application software 300 (see FIG. 2C).

When a read request is made by the application software 300 to an area to be copied and reading of the copy source disk is unsuccessful during the data copying for restoring the disk mirroring state, the copy target disk is set as the new operating disk (and the copy source disk), and the read result of the new operating disk is returned to the upper layer (see FIG. 2D). Consequently, since the area where there is a possibility that data coincidence is not obtained between the copy source disk and the copy target disk satisfies all the conditions mentioned below, the data incoincidence is not a problem.

Since writing is being executed (writing is uncompleted) at the time of the occurrence of the system down, the data may be either data before writing or data after writing.

Since reading has never been performed since the occurrence of the system down, it is unnecessary that the data on the copy target disk coincide with the copy source disk.

Since the area is an uncopied area, when there is a plurality of copy target disks, one of the copy target disks is set as the new operating disk (copy source disk), data is copied to the remaining copy target disks, and after the copying is completed, data coincidence is obtained. By changing the above-mentioned condition “when a read request is made by the application software 300 to an area to be copied” to “when a read request is made by the upper layer to an uncopied area”, extra copying may be omitted. In the description given below, the condition “when a read request is made by the upper layer to an uncopied area” will be mainly described.

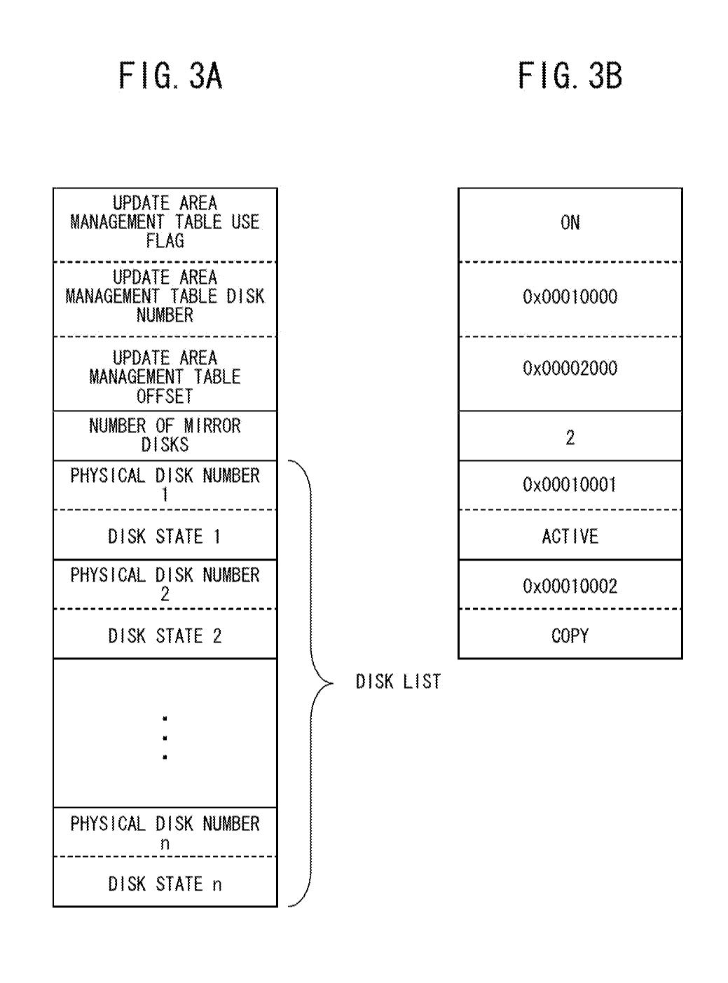

Next, the data structure of the mirror disk structure management table 10 will be described with reference to FIGS. 3A and 3B. First, the data format of the mirror disk structure management table 10 is depicted in FIG. 3A.

An update area management table use flag represents whether to use the update area management table 11 during system operation or not, and takes a value of either “ON” or “OFF”. The value is specified when the user sets the mirroring structure, and may be changed during system operation. The meanings of the values are as follows:

ON

During system operation, the I/O mirroring controller 1 manages the information on the position of the area of the mirror disk 21 being updated, by using the update area management table 11. In this case, in the copying for restoring the disk mirroring state after a system down, the update area management table 11 is referred to, and only the area being updated is copied.

OFF

During system operation, the update area management table 11 is not used. In this case, in the copying for restoring the disk mirroring state after a system down, the entire area of the disk is copied.

An update area management table disk number is a device number of the management information disk 22 storing the update area management table 24. An update area management table offset is the information on the position (offset) of the update area management table 24 on the management information disk 22.

The number of mirror disks is the number of mirror disks 21.

A disk list refers to a list holding a set of a physical disk number and a disk state of each mirror disk 21 in the mirror disk structure management table 10. The physical disk number is the device number of the mirror disk 21. The disk state represents the state of the mirror disk 21, and takes a value of any one of “ACTIVE”, “COPY” and “INVALID”. The meanings of the values are as follows:

ACTIVE

This value indicates that the disk is the operating disk. When there is a plurality of mirror disks 21 that are in the ACTIVE state, data coincidence between the disks is obtained. The disks are targets to which the duplicate of the I/O request (read/write) issued by the application software 300 is issued. In the copying for restoring the disk mirroring state after a system down, one of the mirror disks 21 that are in the ACTIVE state is selected as the operating disk and the copy source disk, and another mirror disk 21 that is in the ACTIVE state becomes the copy target disk by being changed to the COPY state.

COPY

This value indicates that the disk is the copy target disk. In the copying for restoring the disk mirroring state after a system down, one of the mirror disks 21 that are in the ACTIVE state is selected as the operating disk and the copy source disk, and another mirror disk 21 that is in the ACTIVE state becomes the copy target disk by being changed to the COPY state. To the mirror disk 21 set at the value of COPY, data has been copied from the only disk that is in the ACTIVE state (the operating disk=the copy source disk). Although the mirror disk 21 set to the value of COPY is a target to which the duplicate of the write request issued from the application software 300 is issued, the mirror disk 21 set to the value of COPY is not a target of the read request.

INVALID

This value indicates that the disk is isolated from mirroring. That is, the disk is not a target to which the duplicate of the I/O request (read/write) issued by the application software 300 is issued.

FIG. 3B depicts a numerical example of the above-described data format. In the example depicted in FIG. 3B, the numerical values are as follows:

Update area management table: ON

Update area management table disk number: 0x00010000

Update area management table offset: 0x00002000

The number of mirror disks: 2

The physical disk number of a first mirror disk: 0x00010001

The disk state of the first mirror disk: ACTIVE

The physical disk number of a second mirror disk: 0x00010002

The disk state of the second mirror disk: COPY

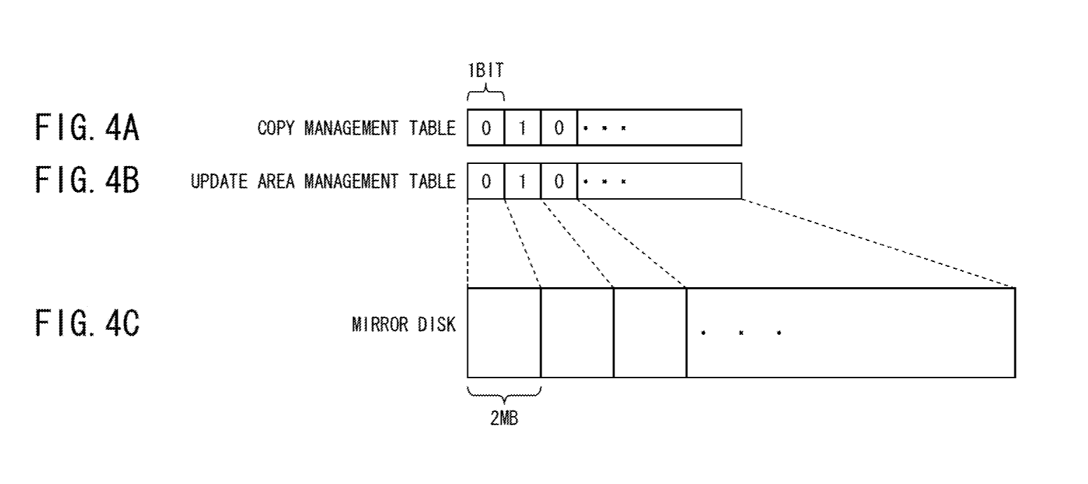

FIGS. 4A to 4C depict the data structures of the copy management table 12 and the update area management table 11 and the association between the bits in the copy management table 12 and the update area management table 11 and the areas of the mirror disk 21. In the present embodiment, the mirror disk 21 is sectioned into areas of two megabytes (see FIG. 4(C)), the copy conditions of the areas are managed by the bits of the copy management table 12, and whether the areas are being updated or not is managed by the bits of the update area management table 11.

The copy management table 12 takes a value of either 0 or 1 (see FIG. 4A). The value 0 indicates that the corresponding area of the mirror disk 21 has already been copied for restoring the mirroring state or is a copy unnecessary area. The value 1 indicates that the corresponding area of the mirror disk 21 is to be copied for restoring the mirroring state. The copy management table 12 is created on the RAM by the copy controller 2 and initialized at the start of the copying for restoring the disk mirroring state after system down.

The method of initializing the copy management table 12 by the copy controller 2 is as follows. When the update area management table use flag is ON, the copy controller 2 copies the update area management table 11 to the copy management table 12. Thus, in the copying for restoring the disk mirroring state after a system down, only the area that is being updated at the time of the system down is copied. On the other hand, when the update area management table use flag is OFF, the copy controller 2 sets 1 to all the bits of the copy management table 12. Consequently, in the copying for restoring the disk mirroring state after system down, all the areas of the disk are copied.

The copy controller 2 copies the areas of the mirror disk 21 corresponding to the bits of 1 among the first to the last bits of the copy management table 12, and changes the corresponding bits to 0. Moreover, when a disk read request is accepted from the application software 300 while the copy controller 2 is executing copying, if the bit corresponding to the area to be read in the copy management table 12 is 1, the I/O mirroring controller 1 copies the area to be read, and changes the bit to 0.

The update area management table 11 takes a value of either 0 or 1 (see FIG. 4B). The value 0 indicates that the corresponding area of the mirror disk 21 is not being updated (is not undergoing writing). The value 1 indicates that the corresponding area of the mirror disk 21 is being updated (is undergoing writing).

When the application software 300 issues a write request to the data holder 200, the I/O mirroring controller 1 sets 1 to the corresponding bit of the update area management table 11 at the start of the writing to the mirror disk 21, and sets 0 at the end of the writing. The I/O mirroring controller 1 does not perform this bit setting processing during the execution of the copying for restoring the disk mirroring state after a system down.

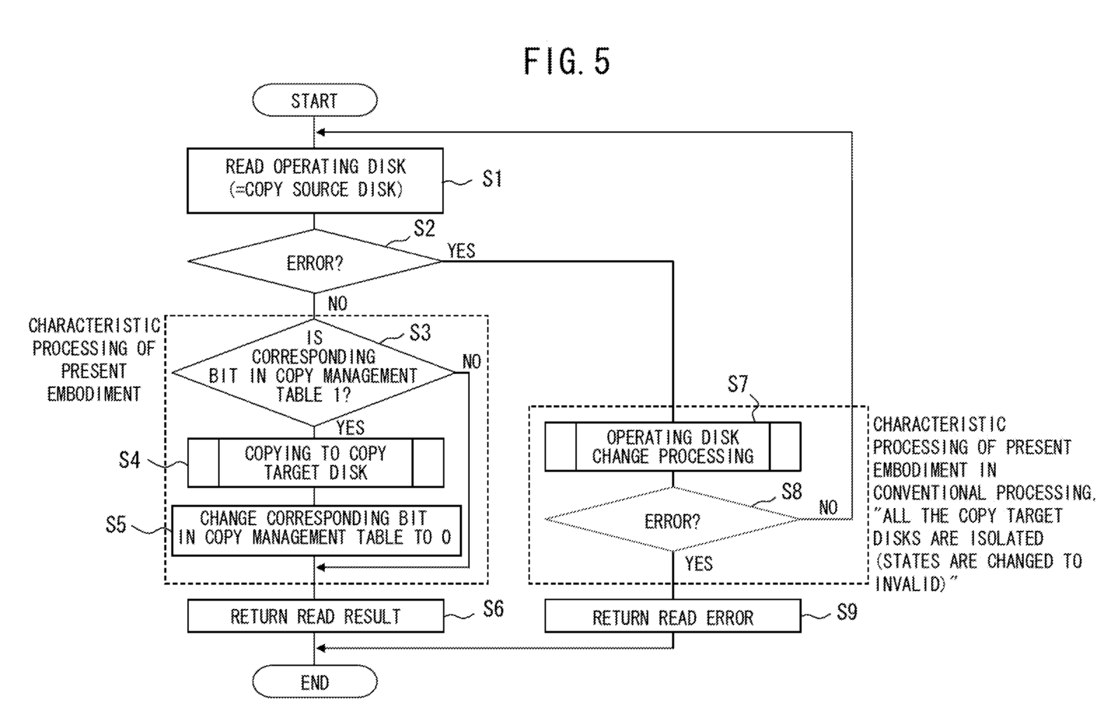

Next, the operation of the storage device 500 according to the present embodiment will be described with reference to the flowcharts of FIGS. 5 to 10. In the flowcharts of FIGS. 5 to 10, the processing indicated by the broken lines are characteristic processing of the present embodiment.

First, the flowchart of the reading during the execution of the restoration copying is depicted in FIG. 5. The flowchart of FIG. 5 depicts a method in which the I/O mirroring controller 1 accepts and processes a read request issued to the data holder 200 by the application software 300 while the copy controller 2 is executing the copying for restoring the disk mirroring state after a system down. In the conventional disk mirroring controller, the copy source disk is read, and when the reading is successful, the read result is returned to the application software and the process ends. On the other hand, when the reading is unsuccessful, all the copy target disks are isolated from mirroring (e.g., the states are changed to INVALID) so that the copy target disks are made non-target disks of the copying, and then, the read error is returned to the application software. In the disk mirroring controller 100 of the present embodiment, when the reading of the copy source disk is successful, if the area has not been copied yet (the corresponding bit of the copy management table 12 is 1), the area is copied, and then, the read result is returned to the application software 300. When the reading of the copy source disk is unsuccessful, one of the copy target disks is set as the new operating disk (that is, the copy source disk), and a read request is issued to the new operating disk.

The steps of the flowchart of FIG. 5 will be described. The I/O mirroring controller 1 reads the operating disk (that is, the copy source disk) based on the request from the application software 300 (S1). The I/O mirroring controller 1 determines whether a read error results or not (S2). When no error results (S2, No), the I/O mirroring controller 1 determines whether the corresponding bit in the copy management table 12 is 1 or not (S3). When the bit is 1 (S3, Yes), copying to the copy target disk (described later) is executed (S4).

The I/O mirroring controller 1 changes the corresponding bit in the copy management table 12 to 0 (S5), and returns the read result to the application software 300 (S6). When the bit is 0 at the bit determination of S3 (S3, No), the processing of S6 is executed.

On the other hand, when the I/O mirroring controller 1 determines that a read error results at the read error determination of S2 (S2, Yes), the I/O mirroring controller 1 executes an operating disk change processing described later (S7). When the operating disk change processing of S7 results in an error (S8, Yes), the I/O mirroring controller 1 returns the read error to the application software 300 (S9). When the operating disk change processing of S7 does not result in an error (S8, No), the process returns to S1.

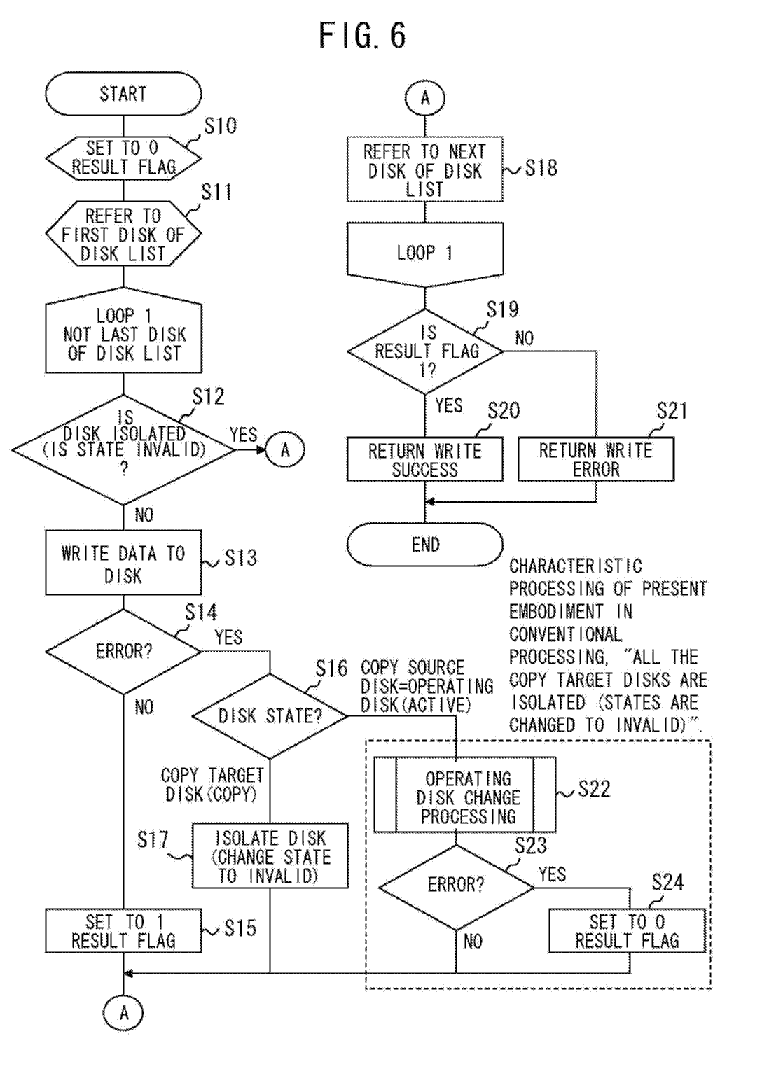

FIG. 6 is a flowchart of writing during the execution of the restoration copying. This flowchart depicts a method in which the I/O mirroring controller 1 accepts and processes a write request issued to the data holder 200 by the application software 300 while the copy controller 2 is executing the copying for restoring the disk mirroring state after a system down. In the conventional disk mirroring controller, when writing to the copy source disk is unsuccessful, all the copy target disks are isolated from mirroring (the states are changed to INVALID) so that the copy target disks are made non-target disks of the copying, and then, the write error is returned to the application software. In the disk mirroring controller 100 according to the present embodiment, when writing to the copy source disk is unsuccessful, one of the copy target disks is set as the new operating disk (that is, the copy source disk), and writing is continued.

The steps depicted in the flowchart of FIG. 6 will be described. The I/O mirroring controller 1 provides a specific flag area on the RAM in the disk mirroring controller 100, and sets the flag to 0 (Hereinafter, such a flag will be referred to as a “result flag”. While the result flag is used as occasion arises in the description of the flowchart given below, it is to be noted that a different result flag is used for each processing.) (S10). Here, the I/O mirroring controller 1 refers to the first disk of the disk list (see FIG. 3A) (S11), and determines whether the mirror disk 21 of the physical disk number that is referred to is isolated (invalid) or not (S12). When the mirror disk 21 is isolated (S12, Yes), the process continues to S18. When the mirror disk 21 is not isolated (S12, No), the I/O mirroring controller 1 writes data to the mirror disk 21 (S13).

The I/O mirroring controller 1 determines whether a write error occurs or not (S14). When no write error occurs (S14, No), the I/O mirroring controller 1 sets the result flag to 1 (S15), and the process continues to S18. When a write error occurs (S14, Yes), the I/O mirroring controller 1 checks the state of the disk from the disk state of the disk list (S16). When the mirror disk 21 where the write error occurs is the copy target disk (S16, COPY TARGET DISK (COPY)), the I/O mirroring controller 1 makes the disk state INVALID to isolate the disk, and the process continues to S18.

When the mirror disk 21 where the write error occurs is the copy source disk (S16, COPY SOURCE DISK=OPERATING DISK (ACTIVE)), the operating disk change processing is executed (S22). When the operating disk change processing ends normally (S23, No), the process continues to S18. When the operating disk change processing ends in an error (S23, Yes), the I/O mirroring controller 1 sets the result flag to 0 (S24), and the process continues to S18.

The I/O mirroring controller 1 refers to the next disk of the disk list (S18). The I/O mirroring controller 1 repetitively executes the processing of S12 to S18 up to the last disk of the disk list.

After the loop from S12 to S18 is completed, the I/O mirroring controller 1 checks the result flag (S19). When the result flag is 1 (S19, Yes), the I/O mirroring controller 1 returns a write success to the application program 300 (S20), and when the result flag is 0 (S19, No), the I/O mirroring controller 1 returns the write error to the application program 300 (S21).

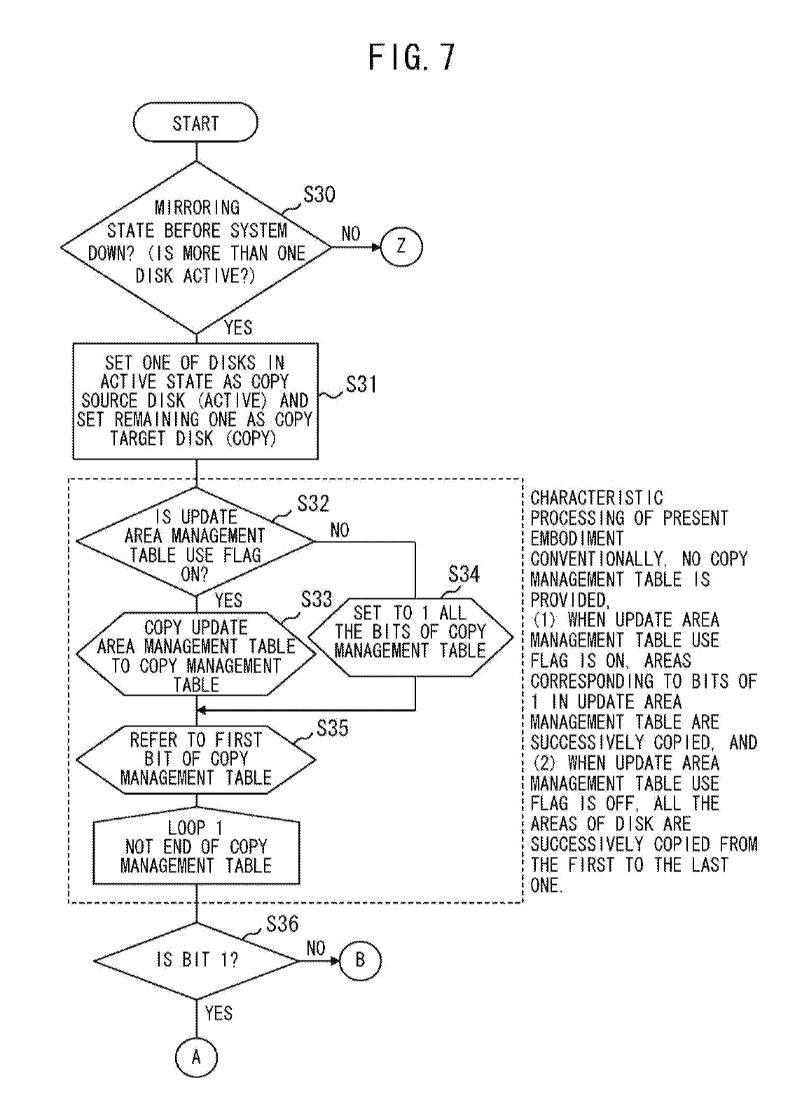

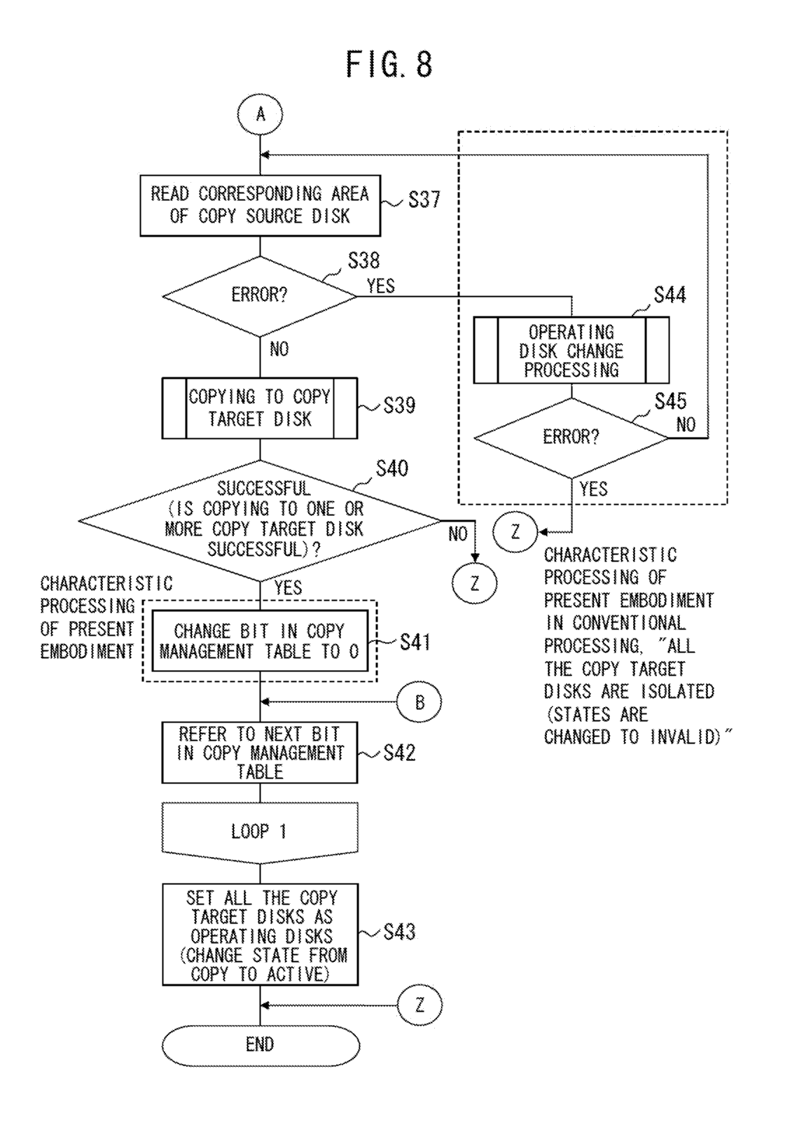

FIGS. 7 and 8 depict flowcharts of the restoration copying. These flowcharts depict the copying executed by the copy controller 2 to restore the disk mirroring state after a system down.

In the conventional disk mirroring controller, when the update area management table use flag is ON, the areas corresponding to the bits of 1 in the update area management table are successively copied. Moreover, when the update area management table use flag is OFF, all the areas of the disk are successively copied from the first area to the last area. In the disk mirroring controller 100 according to the present embodiment, copying is performed not only in the “restoration copying” (FIGS. 7 and 8) by the copy controller 2 but also in the “reading during the execution of the restoration copying” (FIG. 5) and the “writing during the execution of the restoration copying” (FIG. 6) by the I/O mirroring controller 1, and the copy condition is managed by the copy management table 12, whereby it is possible to copy only the uncopied areas.

Moreover, in the conventional disk mirroring controller, when the reading of the copy source disk for the copying is unsuccessful, all the copy target disks are isolated from mirroring (the states are changed to INVALID) and copying is ended. On the other hand, in the disk mirroring controller 100 according to the present invention, when the reading of the copy source disk for the copying is unsuccessful, one of the copy target disks is set as the new operating disk (that is, the copy source disk), and copying is continued.

The steps depicted in the flowcharts of FIGS. 7 and 8 will be described. The copy controller 2 determines whether the disks are in the mirroring state before a system down or not by checking whether more than one disk is in the ACTIVE state based on the disk list in the mirror disk structure management table 10 (S30). When determining that the disks are in the mirroring state before a system down (S30, Yes), the copy controller 2 sets one of the mirror disks 21 that are in the ACTIVE state as the copy source disk (ACTIVE), and sets a remaining disk as the copy target disk (COPY). The copy controller 2 sets, of the mirror disks 21 in the ACTIVE state, the mirror disk 21 corresponding to the physical disk number entered first in the disk list, to the ACTIVE state. On the other hand, when the copy controller 2 determines that the disks are not in the mirroring state before a system down at the determination of S30 (S30, No), the process ends.

The copy controller 2 determines whether the update area management table use flag is ON or not (S32). When update area management table use flag is ON (S32, Yes), the copy controller 2 copies the update area management table 11 to the copy management table 12 (S33). On the other hand, when the update area management table use flag is OFF (S32, No), the copy controller 2 sets 1 to all the bits of the copy management table 12 (S34). Then, the copy controller 2 obtains the first bit of the copy management table 12 (S35).

When the obtained bit is 1 (S36, Yes), the copy controller 2 reads the corresponding area of the copy source disk (S37). When no read error occurs (S38, No), the copy controller 2 executes copying to the copy target disk (S39). The copy controller 2 determines whether the copying of S39 is successful or not (S40). When the copying of S39 is unsuccessful at this step (S40, No), the process ends. On the other hand, when the copying is successful (S40, Yes), the copy controller 2 changes the bit in the copy management table 12 corresponding to the area where the copying is successful, to 0 (S41). Then, the copy controller 2 refers to the next bit in the copy management table (S42), and the process returns to S36.

When it is determined that a read error occurs at S38 (S38, Yes), the copy controller 2 executes the operating disk change processing (S44). When the operating disk change processing is successful (S45, No), the copy controller 2 returns the process to S37, and when an error occurs (S45, Yes), the process ends.

When the value of the obtained bit is 0 at S36 (S36, No), the process proceeds to step S42.

The copy controller 2 repeats the processing of S36 to S42 until the end of the copy management table 12 is reached. Then, the copy controller 2 changes the state from COPY to ACTIVE to set all the copy target disks as operating disks (S43).

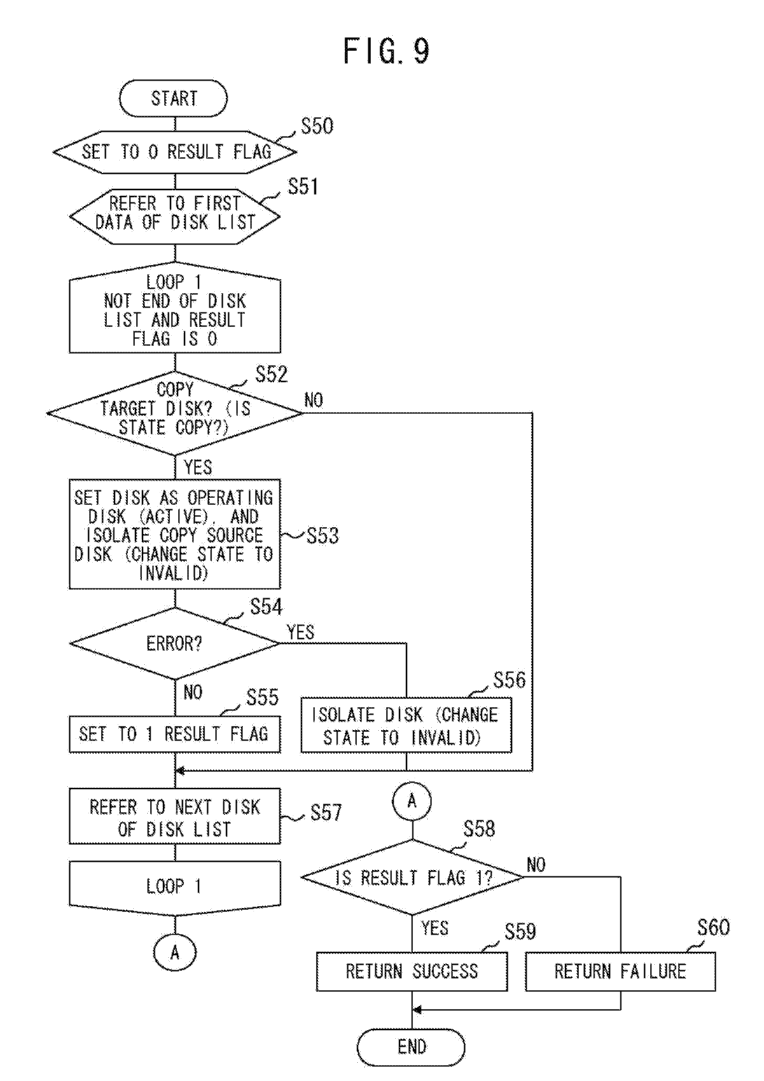

Next, the operating disk change processing will be described with reference to FIG. 9. The flowchart in FIG. 9 depicts processing in which the state of the copy source disk is isolated (e.g., changed to INVALID) from the operating disk (ACTIVE), and the state of one of the copy target disks is changed from the copy target disk (COPY) to the operating disk (ACTIVE). The copy target disk whose state change is unsuccessful is isolated from mirroring (e.g., the state is changed to INVALID). Therefore, when the operating disk cannot be changed, all the copy target disks are isolated from mirroring (e.g., the states are changed to INVALID).

This processing is called when a read or write error occurs at the copy source disk in the “reading during the execution of the restoration copying” (FIG. 5) and the “writing during the execution of the restoration copying” (FIG. 6) by the I/O mirroring controller 1 and the “restoration copying” (FIGS. 7 and 8) by the copy controller 2.

The steps depicted in the flowchart of FIG. 9 will be described. While the operating disk change processing at S7 will be described below, the processing is performed at S22 and S44 as well as at S7 as described above. While in the description given below, the operations of the steps are performed by the I/O mirroring controller 1 since S7 is described as an example (the processing of S22 is also performed by the I/O mirroring controller 1), it is to be noted that the operations of the steps are performed by the copy controller 2 when the processing is performed at S44.

First, the I/O mirroring controller 1 sets the result flag to 0 (S50). The I/O mirroring controller 1 obtains the first data of the disk list (e.g., a set of the physical disk number and the disk state thereof) (S51).

Here, the I/O mirroring controller 1 checks whether the state of the mirror disk 21 corresponding to the obtained physical disk number is COPY or not to determine whether the mirror disk 21 is a copy target disk or not (S52). When the corresponding mirror disk 21 is a copy target disk (S52, Yes), the I/O mirroring controller 1 sets the mirror disk 21 as the operating disk (that is, to the ACTIVE state), and isolates the copy source disk by changing the state thereof to INVALID (S53). When the processing of S53 is successful (S54, No), the result flag is set to 1 (S55), and when the processing of S53 results in an error (S54, Yes), the corresponding mirror disk 21 is isolated (S56).

The I/O mirroring controller 1 obtains the next data in the disk list (a set of the physical disk number and the disk state) (S57), and the process returns to S52.

The I/O mirroring controller 1 repeats the processing of S52 to S57 until the end of the disk list is reached. Here, when the result flag is 1 after S57, the process does not return to S52 but proceeds to S58.

Then, when the result flag is 1 (S58, Yes), the I/O mirroring controller 1 returns the status of success to the caller of the processing (S59), and when the result flag is 0 (S58, No), the I/O mirroring controller 1 returns the status of failure to the caller of the processing (S60).

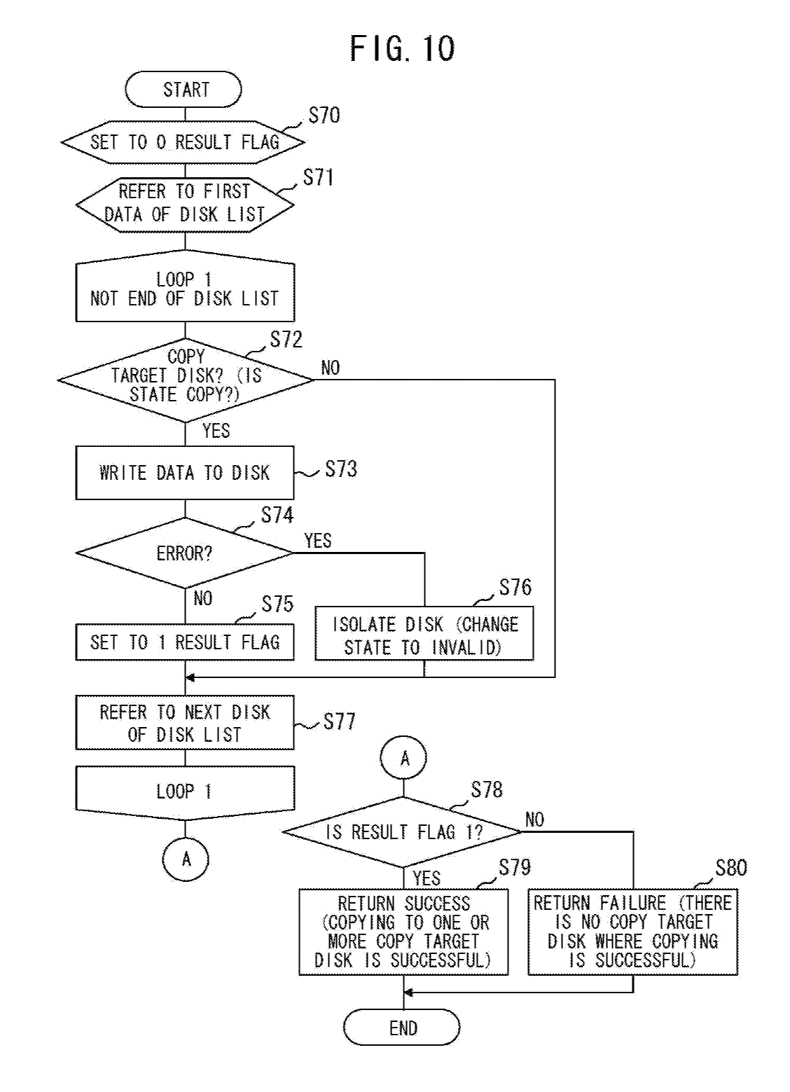

FIG. 10 depicts a flowchart of copying to the copy target disk. The flowchart in FIG. 10 depicts processing in which specified data is copied (written) to a specified area of each copy target disk. The copy target disk where copying (writing) is unsuccessful is isolated from mirroring (e.g., the state is changed to INVALID). When copying (writing) to one or more copy target disk is successful, the successful result is returned to the caller, and when there is no mirror disk 21 where copying (writing) is successful, the failure is returned to the caller.

This processing is called from the “reading during the execution of the restoration copying” (FIG. 5) by the I/O mirroring controller 1 and the “restoration copying” (FIGS. 7 and 8) by the copy controller 2.

The steps depicted in the flowchart of FIG. 10 will be described. While in the description given below, the processing of copying to the copy target disk at S4 will be described below, this processing is also executed at S39 as well as at S4. While the operations of the steps are performed by the I/O mirroring controller 1 since S4 is described as an example, it is to be noted that the steps of the operations are performed by the copy controller 2 when the processing is performed at S39.

The I/O mirroring controller 1 sets 0 to the result flag (S70). The I/O mirroring controller 1 obtains the first data of the disk list (a set of the physical disk number and the disk state) (S71).

Here, the I/O mirroring controller 1 checks whether the state of the disk corresponding to the obtained physical disk number is COPY or not to determine whether the corresponding mirror disk 21 is a copy target disk or not (S72). When the corresponding mirror disk 21 is a copy target disk (S72, Yes), the I/O mirroring controller 1 writes data to the corresponding mirror disk 21 (S73). When a write error occurs (S74, Yes), the I/O mirroring controller 1 isolates the mirror disk 21 where the write error occurs by changing the state to INVALID (S76). On the other hand, when no write error occurs (S74, No), the I/O mirroring controller 1 sets the result flag to 1 (S75).

The I/O mirroring controller 1 obtains the next data in the disk list (a set of the physical disk number and the disk state) (S77), and the process returns to S72. When the corresponding mirror disk 21 is not a copy target disk at S72 (S72, No), the process proceeds to S77.

The I/O mirroring controller 1 repeats the processing of S72 to S77 until the end of the disk list is reached.

When the result flag is 1 (S78, Yes), the I/O mirroring controller 1 returns the status of success indicating that copying to one or more copy target disk is successful, to the caller of the processing (S79), and when the result flag is 0 (S78, No), the I/O mirroring controller 1 returns the status of failure indicating that there is no copy target disk where copying is successful, to the caller of the processing (S80).

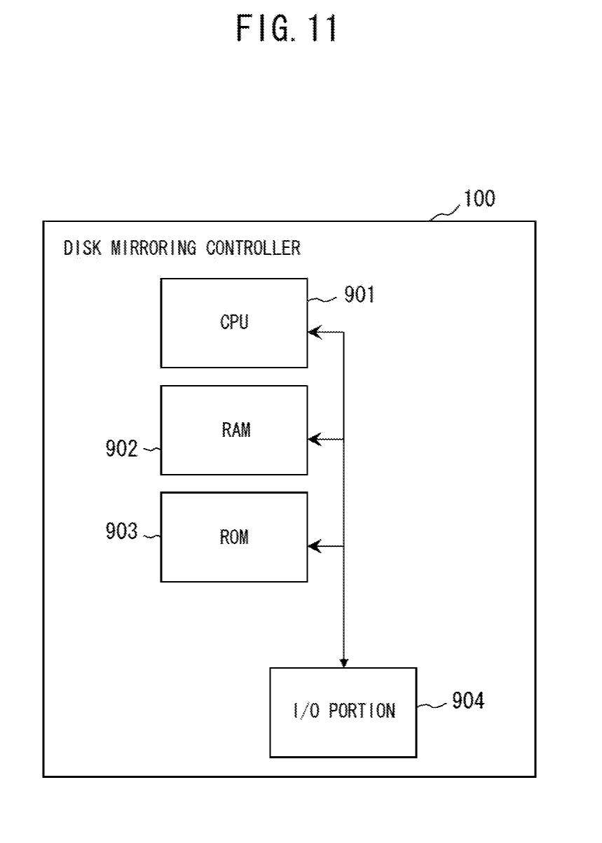

Now, the hardware structure of the disk mirroring controller 100 will be described with reference to FIG. 11. The disk mirroring controller 100 is provided with a CPU (central processing unit) 901 which is an arithmetic processing unit; a RAM (random access memory) 902 which is a main storage; and a ROM (read only memory) 903 which is a nonvolatile storage. The disk mirroring controller 100 is also provided with a bus for data transmission and reception to and from the mirror disks 21 and the management information disk 22 in the data holder 200, and an I/O portion 904 which is a set of buses capable of communication with the upper layer such as the application software 300. The hardware resources of the CPU 901, the RAM 902, the ROM 903, and the I/O portion 904 and the firmware previously held in the ROM 903 operate in concert with one another, whereby the functional blocks in the disk mirroring controller 100 depicted in FIG. 1 are implemented.

The storage device 500 of the present embodiment may be provided in a one-box computer or may accept a data read or write request from an external computer and execute processing based on the request. When the storage device 500 is provided in a one-box computer, the above-described functional portions may be implemented by also using the hardware resources of the CPU, the RAM, the ROM, and the I/O portion in the computer.

The storage device 500 depicted in the present embodiment is applicable to a case where the number of mirrored mirroring disks 21 is two and a case where the number of mirrored mirroring disks 21 is three or more. Moreover, the storage device 500 is applicable to any of the following cases.

The storage device 500 of the present invention is also applicable to a case where after a single-host computer system (non-cluster system) goes down, the disk mirroring state is restored when the system is restarted. Moreover, the storage device 500 is also applicable to a case where in a cluster system in which the data holder 200 is connected to a plurality of host computers as a shared disk, after the operating system goes down, the mirroring state of the data holder 200 is restored by a standby system.

With the disk mirroring controller 100 and the storage device 500 of the present embodiment, even if an error occurs at the copy source disk in the middle of the restoration to the mirroring state, data guarantee and operation continuation may be realized by setting the copy target disk as the new operating disk.

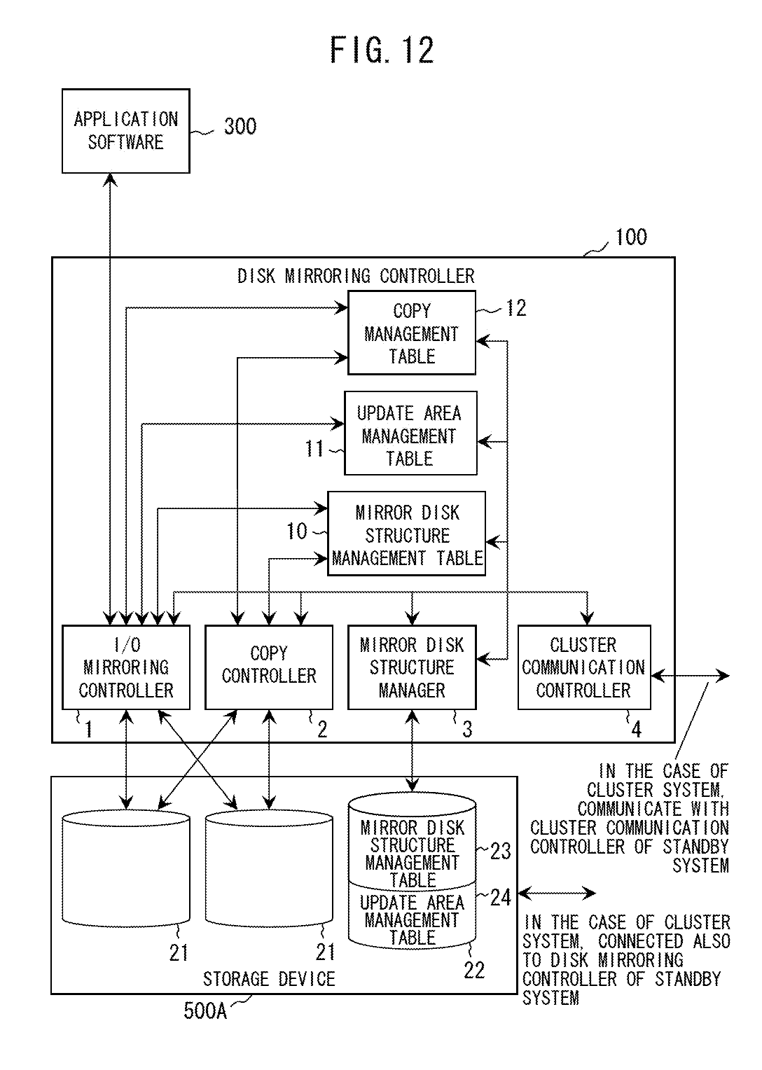

Moreover, the storage device and the disk mirroring controller may be separated as depicted in FIG. 12. Thus, the present embodiment is applicable even to a structure in which the disk mirroring controller 100 is not present in a storage device 500A.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

1. A mirroring controller that maintains data redundancy by a plurality of memories, the mirroring controller comprising:
a copy controller that selects one memory from among the plurality of memories as a copy source memory and, to obtain data equivalence between the plurality of memories, copies data from the copy source memory to at least one copy target memory that is different from the copy source memory, among the plurality of memories; and
an I/O mirroring controller that copies, when a read request to the copy source memory is issued from an upper layer during copying by the copy controller, data from an area corresponding to the read request to the copy target memory,
wherein, when processing corresponding to the read request to the copy source memory from the upper layer results in an error at the copy source memory during the copying by the copy controller, the copy controller controls the copy source memory so as to become unusable, and controls at least one copy target memory so as to act as a memory that performs the processing corresponding to the read request from the upper layer.

2. The mirroring controller according to claim 1,
wherein, when an error occurs in reading data from the area corresponding to the read request when the data in the area is copied to the copy target memory, the I/O mirroring controller controls the copy source memory so as to become unusable, and controls at least one copy target memory so as to act as the memory that performs the processing corresponding to the read request from the upper layer.

3. The mirroring controller according to claim 1,
wherein, when a write request to the plurality of memories is issued from the upper layer and a write error occurs in at least one of the plurality of memories during the copying by the copy controller, the copy controller controls the copy source memory so as to become unusable when the write error occurs at the copy source memory, and controls the at least one copy target memory so as to act as the memory that performs the processing corresponding to the read request from the upper layer.

4. The mirroring controller according to claim 1,
wherein, only when the read request is a read request for an area where the copying by the copy controller has not been completed, the I/O mirroring controller copies the data in the area to the copy target memory.

5. The mirroring controller according to claim 1,
wherein, when a read error with respect to the read request occurs at the copy source memory during the copying by the copy controller, the copy controller copies data in the copy target memory controlled so as to act as the memory that performs the processing corresponding to the read request from the upper layer, to another copy target memory to continue the copying.

6. A storage device comprising:
a plurality of memories; and
a mirroring controller that maintains data redundancy by the plurality of memories,
wherein the mirroring controller includes:
a copy controller that selects one memory from among the plurality of memories as a copy source memory and, to obtain data equivalence between the plurality of memories, copies data from the copy source memory to at least one copy target memory that is different from the copy source memory, among the plurality of memories; and
an I/O mirroring controller that copies, when a read request to the copy source memory is issued from an upper layer during copying by the copy controller, data from an area corresponding to the read request to the copy target memory,
wherein, when processing corresponding to the read request to the copy source memory from the upper layer results in an error at the copy source memory during the copying by the copy controller, the copy controller controls the copy source memory so as to become unusable, and controls at least one copy target memory so as to act as a memory that performs the processing corresponding to the read request from the upper layer.

7. The storage device according to claim 6,
wherein, when an error occurs in reading data from the area corresponding to the read request when the data in the area is copied to the copy target memory, the I/O mirroring controller controls the copy source memory so as to become unusable, and controls at least one copy target memory so as to act as the memory that performs the processing corresponding to the read request from the upper layer.

8. The storage device according to claim 6,
wherein, when a write request to the plurality of memories is issued from the upper layer and a write error occurs in at least one of the plurality of memories during the copying by the copy controller, the copy controller controls the copy source memory so as to become unusable when the write error occurs at the copy source memory, and controls the at least one copy target memory so as to act as the memory that performs the processing corresponding to the read request from the upper layer.

9. The storage device according to claim 6,
wherein, only when the read request is a read request for an area where the copying by the copy controller has not been completed, the I/O mirroring controller copies the data in the area to the copy target memory.

10. The storage device according to claim 6,
wherein, when a read error with respect to the read request occurs at the copy source memory during the copying by the copy controller, the copy controller copies data in the copy target memory controlled so as to act as the memory that performs the processing corresponding to the read request from the upper layer, to another copy target memory to continue the copying.

11. A mirroring control method for maintaining data redundancy by a plurality of memories, the method comprising:
selecting one memory from among the plurality of memories as a copy source memory to obtain data equivalence between the plurality of memories;
copying data from the copy source memory to at least one copy target memory that is different from the copy source memory, among the plurality of memories;
copying, when a read request to the copy source memory is issued from an upper layer during copying to obtain the data equivalence, data from an area corresponding to the read request to the copy target memory; and
when processing corresponding to the read request to the copy source memory from the upper layer results in an error at the copy source memory during the copying to obtain the data equivalence, controlling the copy source memory to become unusable, and controlling at least one copy target memory so as to act as a memory that performs the processing corresponding to the read request from the upper layer.

12. The mirroring control method according to claim 11, further comprising:
when an error occurs in reading data from the area corresponding to the read request when the data in the area is copied to the copy target memory, controlling the copy source memory so as to become unusable, and controlling at least one copy target memory so as to act as the memory that performs the processing corresponding to the read request from the upper layer.

13. The mirroring control method according to claim 11, further comprising:
when a write request to the plurality of memories is issued from the upper layer and a write error occurs in at least one of the plurality of memories during the copying to obtain the data equivalence, controlling the copy source memory so as to become unusable when the write error occurs at the copy source memory, and controlling the at least one copy target memory so as to act as the memory that performs the processing corresponding to the read request from the upper layer.

14. The mirroring control method according to claim 11, further comprising:
only when the read request is a read request for an area where the copying to obtain the data equivalence has not been completed, copying the data in the area to the copy target memory.

15. The mirroring controller according to claim 11, further comprising:
when a read error with respect to the read request occurs at the copy source memory during the copying to obtain the data equivalence, copying data in the copy target memory controlled so as to act as the memory that performs the processing corresponding to the read request from the upper layer, to another copy target memory to continue the copying.
